(19) United States
(12) Patent Application Publication
(10) Pub. No.: US 2011/0320802 A1
(43) Pub. Date: Dec. 29, 2011

(54) AUTHENTICATION METHOD, KEY DISTRIBUTION METHOD AND AUTHENTICATION AND KEY DISTRIBUTION METHOD

(75) Inventors: Jui-Tang Wang, Keelung City (TW); Kuei-Li Huang, Kaohsiung City (TW); Shubhranshu Singh, Banglaore (IN); Gleixner Stephan, Hsinchu County (TW); Jen-Shun Yang, Hsinchu County (TW)

(73) Assignee: INDUSTRIAL TECHNOLOGY RESEARCH INSTITUTE, Hsinchu (TW)

(21) Appl. No.: 13/166,830

(22) Filed: Jun. 23, 2011

Related U.S. Application Data
(60) Provisional application No. 61/357,719, filed on Jun. 23, 2010.

(30) Foreign Application Priority Data
May 17, 2011 (TW) 100117228

(51) Int. Cl. H04W 12/06; H04W 12/04; G06F 9/00

(52) U.S. Cl. 713/2

(57) ABSTRACT

An authentication method, and a key distribution method, and an authentication and key distribution method are provided. The authentication method is adapted for a machine type communication involved with a wireless communication system, and includes the following steps. At least a user equipment (UE) transmits an application request including at least a first security material to a network application function (NAF), where the at least a first security material is not a key directly obtained through a bootstrapping procedure of a generic bootstrapping architecture. The NAF generates a second security material, which is not the key, either. The NAF replies the UE an application answer with the at least a second security material. In addition, the NAF authenticates the UE by the second security material, or the UE authenticates the NAF by the second security material.

### CROSS-REFERENCE TO RELATED APPLICATION

This application claims the priority benefits of U.S.A. provisional application Ser. No. 61/357,719, filed on Jun. 23, 2010 and Taiwan application serial no. 100117228, filed on May 17, 2011. The entirety of each of the above-mentioned patent applications is hereby incorporated by reference herein and made a part of this specification.

### BACKGROUND

1. Field of the Disclosure

The disclosure relates to a device authentication method, a key distribution method and an authentication and key distribution method adapted for machine type communication (MTC).

2. Description of Related Art

Machine type communication (MTC) refers to an information exchange technique between machines performed without (or with rare) human interference through a wireless communication technique. FIG. 1 is a schematic diagram illustrating a MTC network architecture. Referring to FIG. 1, the MTC network architecture includes the Internet 11, an MTC user 120 and MTC devices 101, 102, 103 and 104, etc. Actually, the MTC network may support a large number of MTC devices. The Internet 11 further includes a centralized MTC server 110. The MTC user 120 generally accesses data of the MTC server 110 through an application program interface (API), or further accesses data on the MTC devices 101, 102, 103 and 104. For example, the MTC devices 101, 102, 103 and 104 are vehicular information and communication devices, sensors, water meters, gas meters or electric meters, and data extracted from the MTC devices 101, 102, 103 and 104 can be transmitted to the MTC user 120 through the MTC server 110. Actually, the MTC network can simultaneously support a plurality of different MTC users, and the MTC users can be application servers configured in an internal network of a telecom operator or a mobile network operator (MNO) or application servers outside the network of the MNO.

FIG. 2 illustrates a network architecture of an authentication and key agreement (AKA) mechanism based on a Third generation partnership project (3GPP). The network architecture of FIG. 2 is a generic bootstrapping architecture (GBA). As shown in FIG. 2, the GBA includes a home subscriber server (HSS) 201, at least a bootstrapping server function (BSF) 202, at least a network application function (NAF) 204 and at least an user equipment (UE) 203. Here, the UE 203 is an MTC device, and the NAF is an MTC server. Moreover, the HSS 201 can also be integrated with a home location register (HLR).

Referring to FIG. 2, in the GBA, the HSS 201 is logically connected to the BSF 202 through a Zh′ interface. The BSF 202 is logically connected to the NAF 204 through a Zn interface, the BSF 202 is logically connected to the UE 203 through a Ub interface, and the NAF 204 is logically connected to the UE 203 through a Ua interface. The BSF 202 is generally controlled by an MNO, and the UE 203 performs an AKA mechanism with the HSS 201 through the BSF 202. The HSS 201 stores user security setting parameters.

Based on the aforementioned GBA, a key establishment and key distribution mechanism can be established between the UE 203 and the NAF 204 (or an application server), and a distribution mechanism of a symmetric ciphering key and an integrity key is further implemented. However, in such GBA, a mutual authentication is only implemented between the BSF 202 and the UE 203, and the mutual authentication between the NAF 204 and the UE 203 is not directly implemented.

According to conventional techniques, the mutual authentication between the BSF 202 and the UE 203 is performed through the HSS 201 by using an AKA mechanism of a hypertext transfer protocol (HTTP) digest. Namely, the UE 203 authenticates an identity of the BSF 202, and the BSF 202 also authenticates an identity of the UE 203. Then, the UE 203 and the BSF 202 respectively obtain a pair of the ciphering key and the integrity key (CK, IK) used for a session layer, and obtain a key Ks by combining the ciphering key and the integrity key (CK, IK).

Further, based on a bootstrapping security association procedure shown in FIG. 3, the UE 203 and the NAF 204 obtain a network application function key Ks_NAF through the BSF 202. FIG. 3 is a schematic flowchart illustrating the bootstrapping security association procedure. Referring to FIG. 3, in step 30, the UE 203 obtains the key Ks and a bootstrapping transaction ID (B-TID). In step 31, similarly, the BSF 202 obtains the key Ks and the B-TID. In step 301, the UE 203 obtains the network application function key Ks_NAF according to the key Ks. In step 302, the UE 203 sends an application request to the NAF 204, where the application request includes the B-TID and related message(s). In step S303, the NAF 204 sends an authentication request to the BSF 202, where the authentication request includes the B-TID and a network application function transaction ID (NAF-TID).

In step S304, the BSF 202 obtains the network application function key Ks_NAF according to the key Ks. In step S305, the BSF 202 replies an authentication answer to the NAF 204, where the authentication answer includes the network application function key Ks_NAF, a key lifetime Key_lifetime of the network application function key Ks_NAF and a corresponding user profile. Here, the user profile can be a user security setting. In step 306, the NAF 204 stores the received network application function key Ks_NAF, the key lifetime and the corresponding user profile. In step 307, the NAF 204 replies the UE 203 an application answer.

To be illustrated more clearly, in the flow of FIG. 3, the NAF 204 authenticates the UE 203 through the BSF 202, though the UE 203 does not authenticate the BSF 202. Therefore, the flow of the conventional technique has a security problem (loophole). Moreover, according to the technical specification 22.368 of the 3GPP (3GPP TS 22.368), a basic requirement of the MTC application is that the MNO has to provide an efficient security mechanism for connections of the MTC devices and the MTC server.

Furthermore, such efficient security mechanism has to comply with the following requirements. For example, an authentication between the MTC devices requires a communication service layer authentication between the machines or a communication application authentication between the machines. Moreover, the aforementioned authentication mechanism is required to ensure data integrity, data privacy and mutual authentication and mutual authorization of devices at two ends of the MTC application. However, the conventional technique is not totally complied with the requirements of the aforementioned authentication mechanism. Therefore, how to suitably modify the conventional authentication procedures in order to meet requirements of the aforementioned authentication mechanism based on a communication protocol of the existing GBA is an important issue in the industry.

### SUMMARY

An exemplary embodiment of the disclosure provides an authentication method adapted for a wireless communication system including a home subscriber server (HSS), a bootstrapping server function (BSF), a network application function (NAF) and at least one user equipment (UE). The authentication method is adapted for machine type communication and includes following steps. The at least a user equipment transmits an application request including at least a first security material to the NAF, where the first security material is not a first key directly obtained through a bootstrapping procedure of a generic bootstrapping architecture. The NAF generates a second security material according to the first security material, where the second security material is not the first key directly obtained through the bootstrapping procedure of the generic bootstrapping architecture, either. Moreover, the NAF replies an application answer including the at least a second security material to the at least a user equipment. In addition, the NAF authenticates the at least a user equipment according to the second security material, or the at least a user equipment authenticates the NAF according to the second security material.

An exemplary embodiment of the disclosure provides a key distribution method adapted for a wireless communication system including a home subscriber server (HSS), a bootstrapping server function (BSF), a network application function (NAF) and at least one user equipment (UE). The key distribution method is adapted for machine type communication and includes following steps. The at least a user equipment transmits a traffic key request to the NAF, where the traffic key request includes an identification code. The NAF generates a traffic key and ciphers the traffic key by a key encryption key to generate a security parameter. Moreover, the NAF replies a traffic key acknowledgement including the security parameter to the at least a user equipment.

An exemplary embodiment of the disclosure provides an authentication and key distribution method adapted for a wireless communication system including a home subscriber server (HSS), a bootstrapping server function (BSF), a network application function (NAF) and at least one user equipment (UE). The authentication and key distribution method is adapted for machine type communication and includes following steps. The at least a user equipment transmits an application request including a first identification code, a first security parameter and a message to the NAF. The NAF transmits an authentication request including the first identification code and a second identification code to the BSF after receiving the application request. The BSF replies an authentication answer including a network application function key, a key lifetime of the network application function key, and a user profile of the network application function key to the NAF. The NAF replies an application answer including at least a first message authentication code, a second security parameter and a third security parameter to the UE. Moreover, the UE transmits an application acknowledgement including a second message authentication code to the NAF.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating a machine type communication (MTC) network architecture.

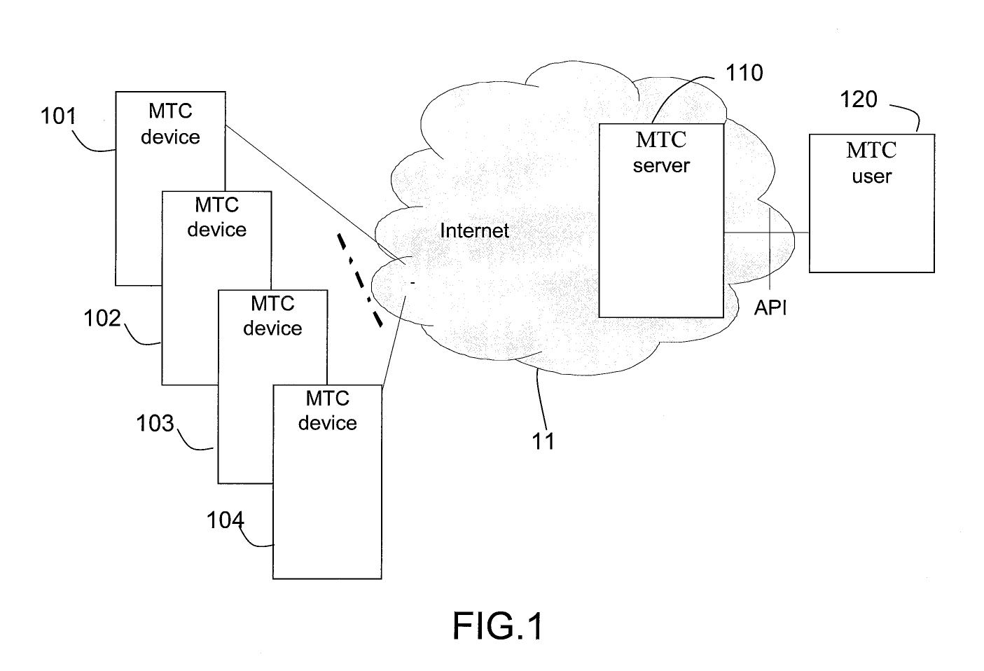

FIG. 2 illustrates a network architecture of an authentication and key agreement (AKA) mechanism based on a Third generation partnership project (3GPP).

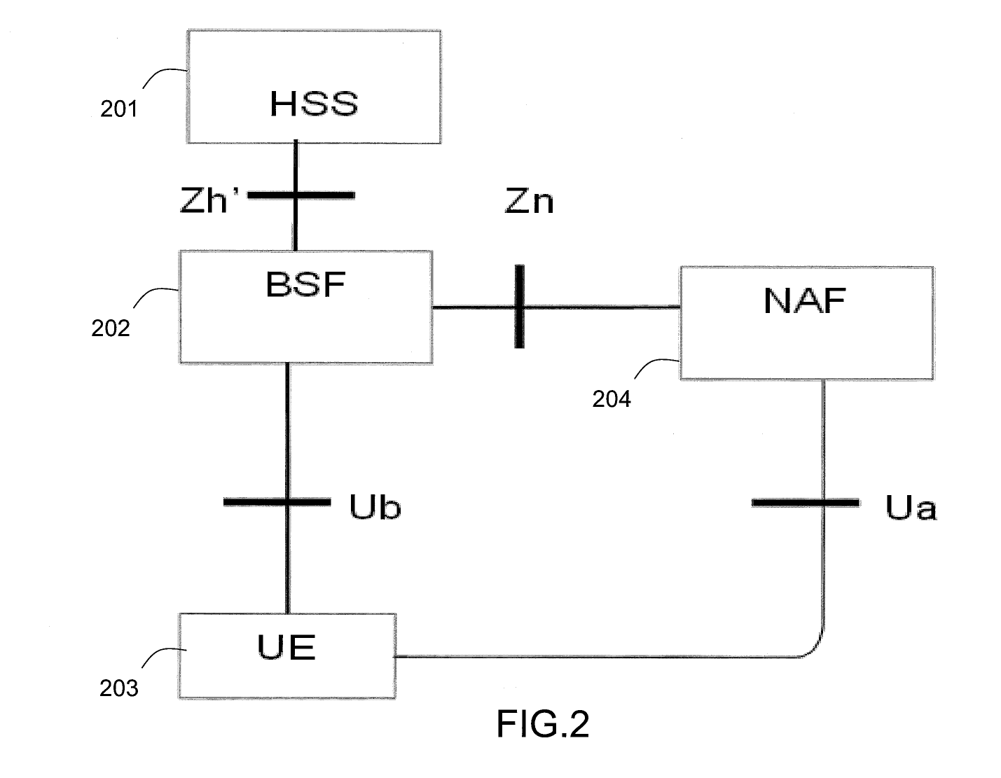

FIG. 3 is a schematic flowchart illustrating a bootstrapping security association procedure.

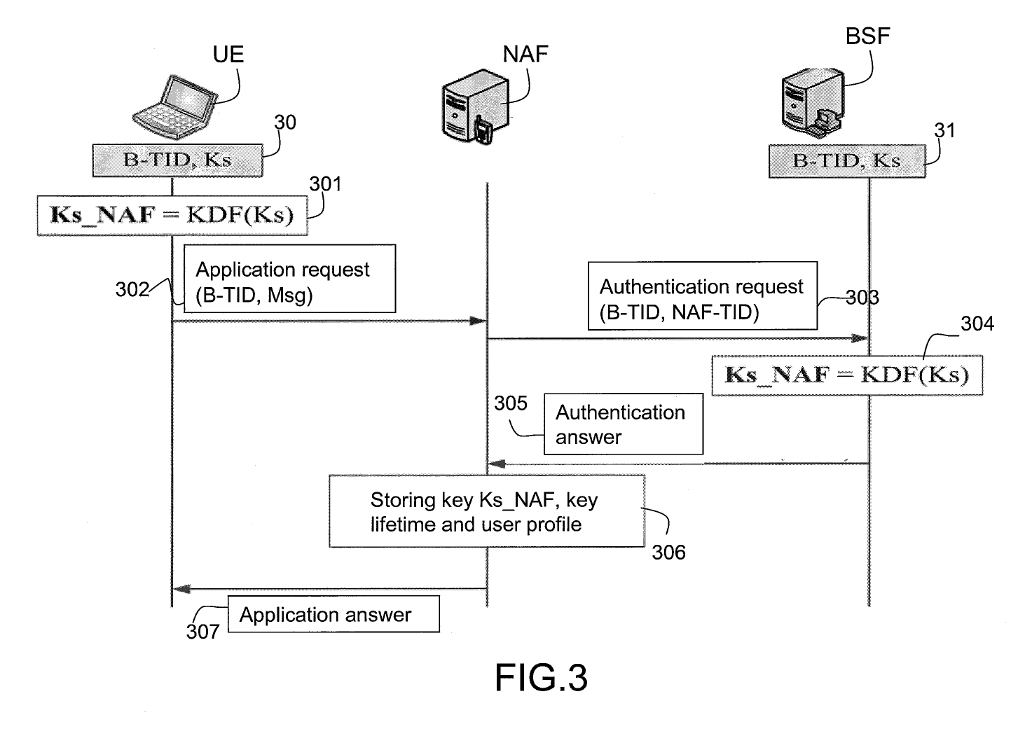

FIG. 4 is a schematic flowchart illustrating a device authentication method according to a first exemplary embodiment of the disclosure.

FIG. 5 is a schematic flowchart illustrating a device authentication method according to a second exemplary embodiment of the disclosure.

FIG. 6 is a schematic flowchart illustrating a device authentication method according to a third exemplary embodiment of the disclosure.

FIG. 7 is a schematic flowchart illustrating a device authentication method according to a fourth exemplary embodiment of the disclosure.

FIG. 8 is a schematic flowchart illustrating a mutual authentication method according to a fifth exemplary embodiment of the disclosure.

FIG. 9 is a schematic flowchart illustrating a mutual authentication method according to a sixth exemplary embodiment of the disclosure.

FIG. 10 is a schematic flowchart illustrating a key distribution method according to a seventh exemplary embodiment of the disclosure.

FIG. 11 is a schematic flowchart illustrating an authentication and key distribution method according to an eighth exemplary embodiment of the disclosure.

### DETAILED DESCRIPTION

In the following disclosure, the term “user equipment (UE)” can be referred to a mobile station (MS) or an advanced mobile station (AMS) or a machine type communication (MTC) device. The MTC device is, for example, a vehicular information and communication device, a sensor, a water meter, a gas meter, an electric meter, a sensor device, a digital camera, a mobile phone, a smart phone, a personal computer (PC), a notebook computer (PC), a netbook, a digital television, a flat panel PC, etc. Moreover, the term “network application function (NAF)” referred in the following disclosure can be a MTC server.

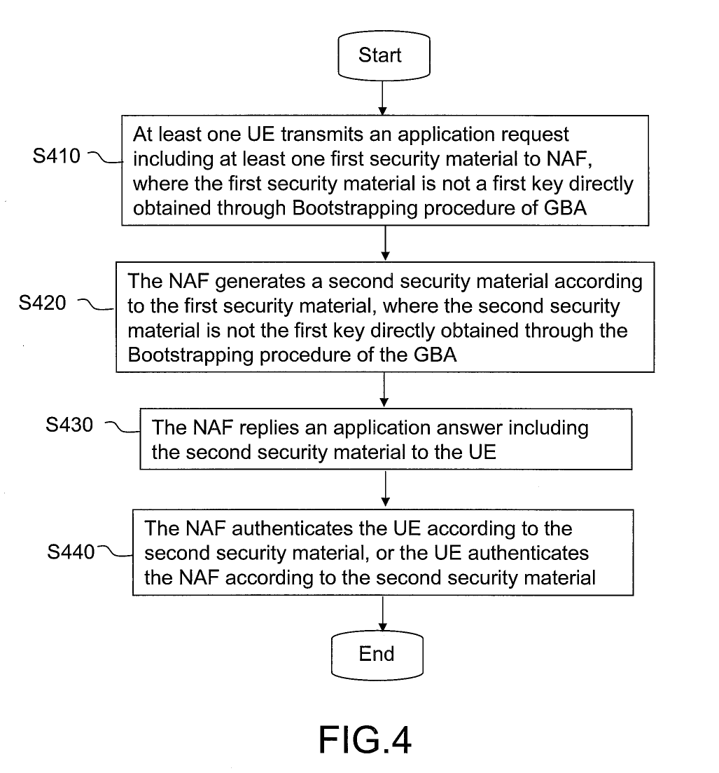

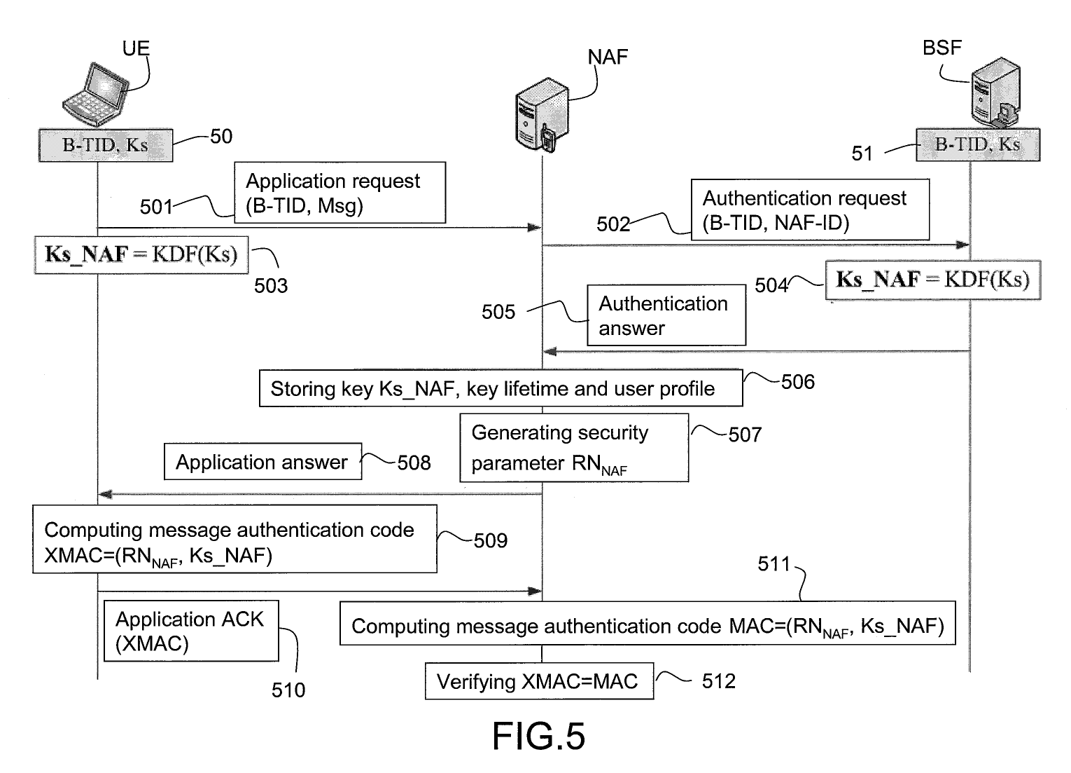

FIG. 4 is a schematic flowchart illustrating a device authentication method according to a first exemplary embodiment of the disclosure. The device authentication method schematically includes following steps. In step S410, at least one user equipment (for example, a user equipment UE of FIG. 5) transmits an application request including at least a first security material to a network application function, where the first security material is not a first key directly obtained through a bootstrapping procedure of a generic bootstrapping architecture (GBA).

In step S420, the network application function generates a second security material according to the first security material, where the second security material is not the first key directly obtained through the bootstrapping procedure of the GBA. In step S430, the network application function replies an application answer including the second security material to the user equipment. In step S440, the network application function authenticates the user equipment according to the second security material, or the user equipment authenticates the network application function according to the second security material. Then, the device authentication method of FIG. 4 is ended.

In the present disclosure, different implementations of the first exemplary embodiment are described in detail in accordance with following second to sixth exemplary embodiments respectively corresponding to FIG. 5 to FIG. 9.

FIG. 5 is a schematic flowchart illustrating a device authentication method according to a second exemplary embodiment of the disclosure. The device authentication method of FIG. 5 implements the device authentication based on a shared key between a user equipment UE and a network application function NAF. Referring to FIG. 5, in step 50, the user equipment UE obtains a key Ks and a bootstrapping transaction ID B-TID through the bootstrapping procedure of the GBA. In step 51, similarly, a bootstrapping server function BSF obtains the key Ks and the bootstrapping transaction ID B-TID through the bootstrapping procedure of the GBA. Also, the bootstrapping transaction ID B-TID is a transaction identification code.

Actually, the device authentication method initiates from a step 501. In the step 501, the user equipment UE sends an application request to the network application function NAF, where the application request includes the bootstrapping transaction ID B-TID and related message(s). In step 502, the network application function NAF sends an authentication request to the bootstrapping server function BSF, where the authentication request includes the bootstrapping transaction ID B-TID and a network application function transaction ID NAF-TID. Also, the network application function transaction ID NAF-TID is a transaction identification code.

In step 503, the user equipment UE generates a network application function key Ks_NAF according to the key Ks, for example, Ks_NAF=KDF (Ks), where KDF is a key generation function. In step 504, the bootstrapping server function BSF generates the network application function key Ks_NAF according to the key Ks. It is noted that the step 503 can be executed while the steps 501 and 502 are executed, or can be executed before the step 501.

In step 505, the bootstrapping server function BSF replies an authentication answer to the network application function NAF, where the authentication answer includes the network application function key Ks_NAF, a key lifetime of the network application function key Ks_NAF and a corresponding user profile. Here, the user profile can be a user security setting. In step 506, the network application function NAF stores the received network application function key Ks_NAF, the key lifetime and the corresponding user profile. In step 507, the network application function NAF generates a security parameter RN_{NAF}, where the security parameter RN_{NAF} is a random instance, which is, for example, a random number, a geographic position parameter (for example, a longitude and a latitude) of the user equipment UE, any name configured by the user of the user equipment UE, a user name of the user of the user equipment UE, an medium access control (MAC) address ID of the user equipment UE, or the above parameters plus an index, etc.

In step 508, the network application function NAF replies an application answer to the user equipment UE, where the application answer includes the security parameter RN_{NAF} generated by the network application function NAF.

In step 509, the user equipment UE computes or calculates a message authentication code XMAC=(RN_{NAF}, Ks_NAF) according to a calculation method of message authentication code XMAC previously agreed through protocol between the network application function NAF and the user equipment UE by using the received security parameter RN_{NAF} and the network application function key Ks_NAF. In step 510, the user equipment UE replies an application acknowledgement (application ACK) to the network application function NAF, where the application ACK includes the message authentication code XMAC generated by the user equipment UE.

In step 511, the network application function NAF computes or calculates a message authentication code MAC=(RN_{NAF}, Ks_NAF) according to a calculation method of the message authentication code MAC previously agreed through protocol between the network application function NAF and the user equipment UE by using the previously generated security parameter RN_{NAF} and the network application function key Ks_NAF. The message authentication code MAC and the message authentication code XMAC are security symmetric, so that in step 512, the network application function NAF determines whether the received message authentication code XMAC is equal to the generated message authentication code MAC. This is to determine whether XMAC=MAC, and if XMAC=MAC, the network application function NAF can authenticate the user equipment UE, which is a one-way device authentication.

In the step 512, if a determination result is negative, i.e., the received message authentication code XMAC is not equal to the generated message authentication code MAC, the authentication result is failed, and the network application function NAF regards the user equipment UE as an unreal MTC device. The network application function NAF and the user equipment UE have to repeat the aforementioned device authentication method from the step 501.

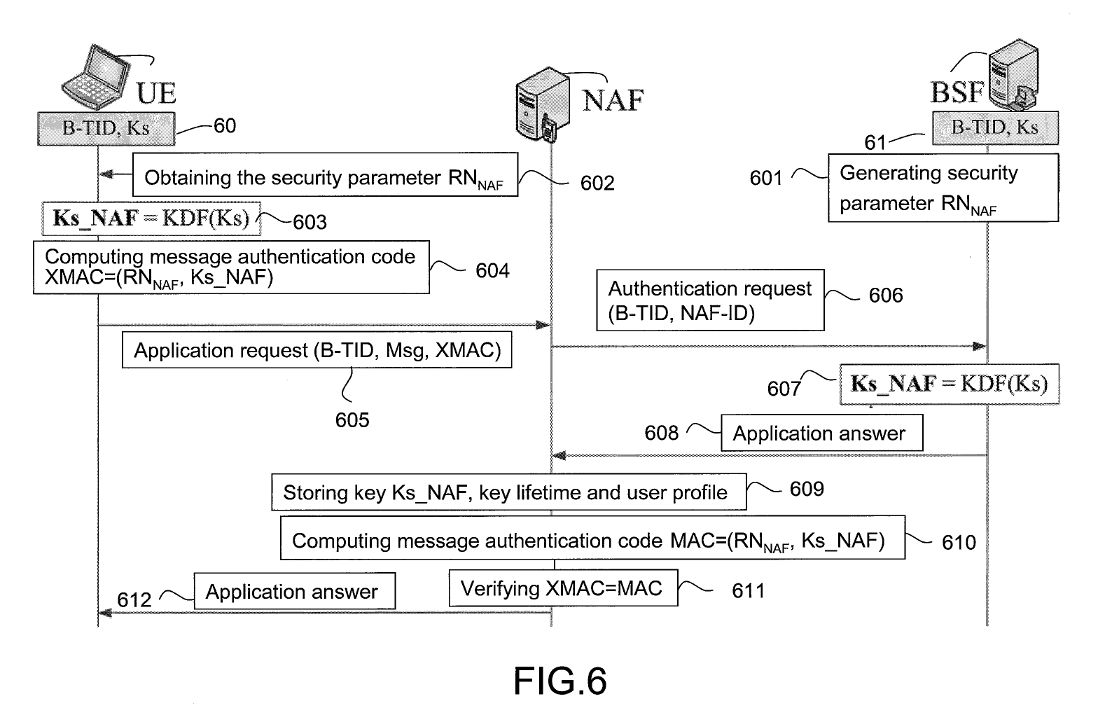

FIG. 6 is a schematic flowchart illustrating another device authentication method according to a third exemplary embodiment of the disclosure. The device authentication method of FIG. 6 implements the device authentication based on a shared key and pre-information between the user equipment UE and the network application function NAF. Referring to FIG. 6, steps 60 and 61 are respectively similar to the step 50 and the step 51, and the user equipment UE and the network application function NAF respectively obtain a key Ks and a bootstrapping transaction ID B-TID through the bootstrapping procedure of the GBA.

In step 601, the bootstrapping server function BSF generates a security parameter RN_{NAF}, which is similar to the security parameter RN_{NAF} obtained in the step 507 of FIG. 5. However, the present disclosure is not limited thereto, and in other embodiments, in step 602, the user equipment UE can obtain the security parameter RN_{NAF} from an HSS when performing the authentication with the HSS of a home network, and the authentication can be, for example, an authentication procedure in the bootstrapping procedure. Moreover, in the step 602, the HSS can provide the security parameter RN_{NAF} to the bootstrapping server function BSF and the user equipment UE, and the security parameter RN_{NAF} obtained by the user equipment UE is the pre-information.

In step 603, the user equipment UE generates a network application function key Ks_NAF according to the key Ks obtained when performing the bootstrapping procedure with the HSS, for example, Ks_NAF=KDF (Ks). In step 604, the user equipment UE calculates a message authentication code XMAC=(RN_{NAF}, Ks_NAF) according to a calculation method of the message authentication code XMAC agreed previously through protocol between the network application function NAF and the user equipment UE by using the received security parameter RN_{NAF} and the network application function key Ks_NAF.

Referring to FIG. 6, the device authentication method actually initiates from a step 605. In the step 605, the user equipment UE sends an application request to the network application function NAF, where the application request includes the bootstrapping transaction ID B-TID, the related message(s) and the message authentication code XMAC. In step 606, the network application function NAF sends an authentication request to the bootstrapping server function BSF, where the authentication request includes the bootstrapping transaction ID B-TID and a network application function transaction ID NAF-TID. In step S607, the bootstrapping server function BSF generates the network application function key Ks_NAF according to the key Ks, for example, Ks_NAF=KDF (Ks).

In step S608, the bootstrapping server function BSF replies an authentication answer to the network application function NAF, where the authentication answer includes the network application function key Ks NAF, a key lifetime of the network application function key Ks_NAF, a corresponding user profile and the security parameter RN_{NAF}. Here, the user profile can be a user security setting. In step 609, the network application function NAF stores the received network application function key Ks_NAF, the key lifetime, the corresponding user profile and the security parameter RN_{NAF}.

In step 610, the network application function NAF computes or calculates a message authentication code MAC=(RN_{NAF}, Ks_NAF) according to a calculation method of the message authentication code MAC previously agreed through protocol between the network application function NAF and the user equipment UE by using the obtained security parameter RN_{NAF} and the network application function key Ks_NAF.

The message authentication code MAC and the message authentication code XMAC are security symmetric, so that in step 611, the network application function NAF determines whether the message authentication code XMAC received in the step 605 is equal to the generated message authentication code MAC. This is to determine whether XMAC=MAC, and if XMAC=MAC, the network application function NAF can authenticate the user equipment UE, which is a one-way device authentication.

In the step 612, the network application function NAF replies an application ACK to the user equipment UE to confirm that the one-way device authentication is completed. In the above step 611, if a determination result is negative, i.e., the received message authentication code XMAC is not equal to the generated message authentication code MAC, the authentication result is failed, and the network application function NAF regards the user equipment UE as an unreal MTC device. The network application function NAF and the user equipment UE have to repeat the aforementioned device authentication method from the step 605.

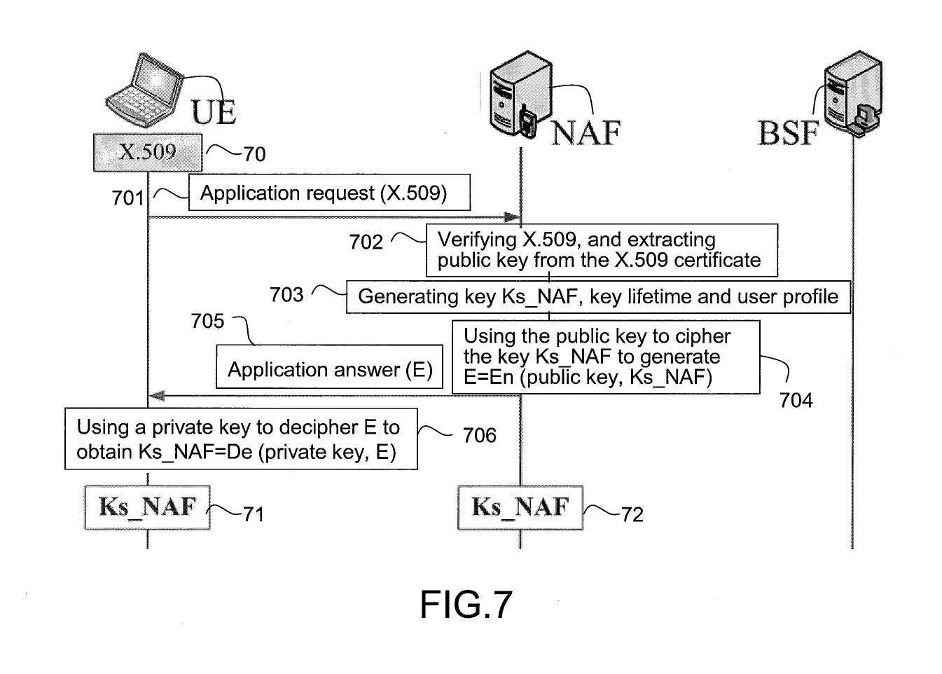

FIG. 7 is a schematic flowchart illustrating another device authentication method according to a fourth exemplary embodiment of the disclosure. The device authentication method of FIG. 7 is different from the device authentication method of FIG. 5 and the device authentication method of FIG. 6. The device authentication method of the fourth exemplary embodiment mainly implements the one-way device authentication between the network application function NAF and the user equipment UE according to an X.509 standard based on a public key infrastructure (PM). Referring to FIG. 7, in step 70, the user equipment UE obtains an X.509 certificate from a certificate authority (CA), though the certificate authority is not illustrated in FIG. 7. In step 701, the user equipment UE sends an application request to the network application function NAF, where the application request includes the obtained X.509 certificate. In step 702, the network application function NAF verifies the X.509 certificate, and extracts a public key from the X.509 certificate. Thus, the network application function NAF authenticates the user equipment UE.

In step 703, the network application function NAF generates a network application function key Ks NAF, a key lifetime of the network application function key Ks_NAF, and a corresponding user profile. It is noted that in step 704, the network application function NAF ciphers the network application function key Ks_NAF by using the extracted public key to generate a security parameter E=En (the public key, the network application function key Ks_NAF), where a function En (A,B) represents using a parameter A to cipher a parameter B.

In step 705, the network application function NAF replies an application answer to the user equipment UE, where the application answer includes the generated security parameter E. In step 706, the user equipment UE uses a private key corresponding to the public key in the X.509 certificate obtained from the certificate authority (not shown) to decipher the received security parameter E to obtain the network application function key Ks_NAF=De (the private key, the security parameter E), where a function De (C, D) represents using a parameter C to decipher a parameter D. Thus, the user equipment UE authenticates the network application function NAF. The user equipment UE sends an application ACK to the network application function NAF. Then, in step 71 and step 72, the user equipment UE and the network application function NAF respectively use the network application function key Ks_NAF to perform subsequent processing, for example, authentication and data transmission, etc.

In the aforementioned step 706, if the authentication result is failed, the network application function NAF and the user equipment UE have to repeat the aforementioned device authentication method from the step 701.

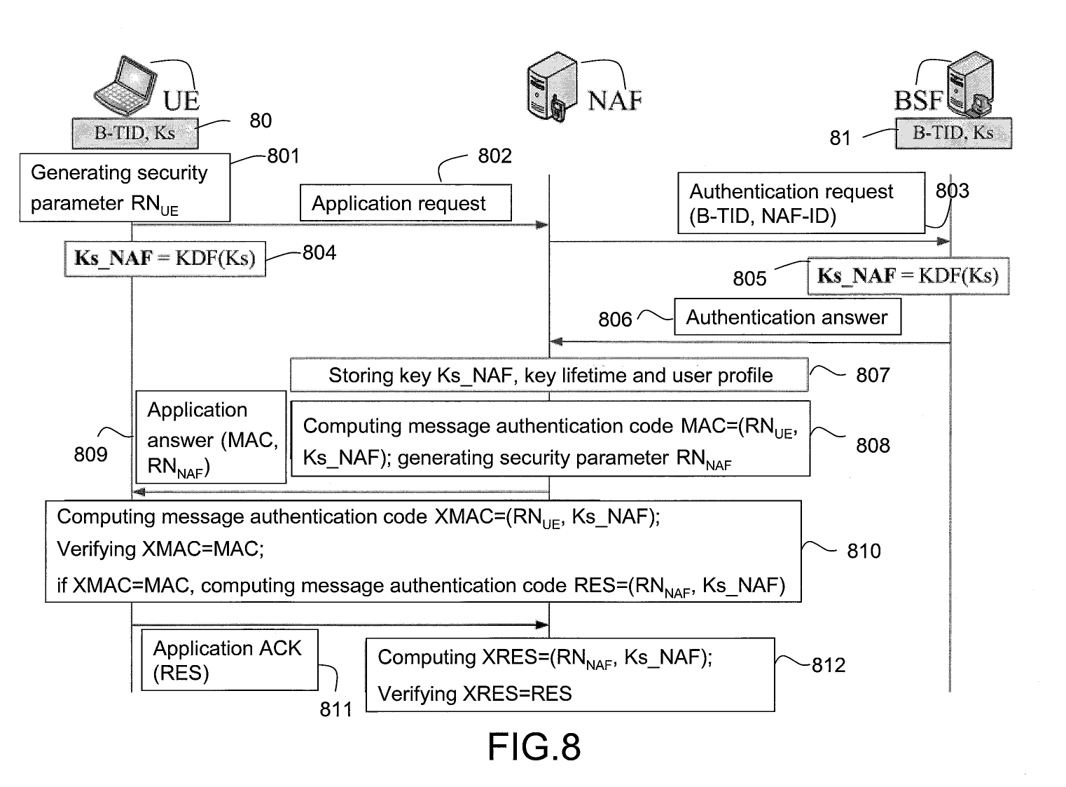

FIG. 8 is a schematic flowchart illustrating a mutual authentication method according to a fifth exemplary embodiment of the disclosure. The device authentication method of FIG. 8 mainly implements the device authentication based on a shared key between the user equipment UE and the network application function NAF. Therefore, in the mutual authentication method, a security parameter is required to be generated at both of the user equipment UE and the network application function NAF. Referring to FIG. 8, steps 80 and 81 are respectively similar to the step 50 and the step 51, and the user equipment UE and the bootstrapping server function BSF respectively obtain a key Ks and a bootstrapping transaction ID B-TID.

In step 801, the user equipment UE generates a security parameter RN_{UE}. In step 802, the user equipment UE sends an application request to the network application function NAF, where the application request includes the bootstrapping transaction ID B-TID, related message(s) Msg and the security parameter RN_{UE}. In step 803, the network application function NAF sends an authentication request to the bootstrapping server function BSF, where the authentication request includes the bootstrapping transaction ID B-TID and a network application function transaction ID NAF-TID.

In step S804, the user equipment UE generates a network application function key Ks_NAF according to the key Ks, for example, Ks_NAF=KDF (Ks), where KDF is a key generation function. Moreover, in other embodiments, the user equipment UE can also use the bootstrapping transaction ID B-TID and the network application function transaction ID NAF-TID as indexes of the key Ks, and generates the network application function key Ks_NAF according to the indexes and the key Ks, for example, Ks_NAF=KDF (Ks, index). In step 805, the bootstrapping server function BSF generates the network application function key Ks_NAF according to the key Ks, for example, Ks NAF=KDF (Ks). It is noted that the step 804 can be executed while the step 801 to the step 803 are executed, or can be executed before the step 801.

In step 806, the bootstrapping server function BSF replies an authentication answer to the network application function NAF, where the authentication answer includes the network application function key Ks_NAF, a key lifetime of the network application function key Ks_NAF, and a corresponding user profile. Here, the user profile can be a user security setting. In step 807, the network application function NAF stores the received network application function key Ks_NAF, the key lifetime, and the corresponding user profile. In step 808, the network application function NAF computes or calculates a message authentication code MAC=(RN_{UE}, Ks_NAF) according to a calculation method of the message authentication code MAC previously agreed through protocol between the network application function NAF and the user equipment UE by using the obtained security parameter RN_{UE} and the network application function key Ks_NAF, and generates a message security parameter RN_{NAF}.

In the step 809, the network application function NAF replies an application answer to the user equipment UE, where the application answer includes the message authentication code MAC and the network application function key Ks_NAF.

In step 810, the user equipment UE calculates a message authentication code XMAC=(RN_{UE}, Ks_NAF) according to a calculation method of the message authentication code XMAC agreed previously through protocol between the network application function NAF and the user equipment UE by using the security parameter RN_{UE} and the network application function key Ks_NAF. Since the message authentication code XMAC and the message authentication code MAC are security symmetric, the user equipment UE further determines whether the generated message authentication code XMAC is equal to the message authentication code MAC received in the step 809. This is to determine whether XMAC=MAC, and if XMAC=MAC, the user equipment UE authenticates the network application function NAF. Therefore, the user equipment UE further computes or calculates another message authentication code RES=(RN_{NAF}, Ks_NAF) according to a calculation method of the message authentication code RES agreed previously through protocol between the network application function NAF and the user equipment UE by using the message security parameter RN_{NAF} and the network application function key Ks_NAF received in the step 809.

In step 811, the user equipment UE replies an application acknowledgement (ACK) to the network application function NAF, where the application ACK includes the message authentication code RES.

In step 812, the network application function NAF computes or calculates a message authentication code XRES=(RN_{NAF}, Ks_NAF) according to a calculation method of the message authentication code XRES agreed previously through protocol between the network application function NAF and the user equipment UE by using the message security parameter RN_{NAF} and the network application function key Ks_NAF. Since the message authentication code XRES and the message authentication code RES are security symmetric, the network application function NAF further determines whether the generated message authentication code)(RES is equal to the message authentication code RES received in the step 811. This is to determine whether XRES=RES, and if XRES=RES, the network application function NAF authenticates the user equipment UE. As such, the mutual authentication between the user equipment UE and the network application function NAF is completed.

In the step 810, if the message authentication code XMAC is not equal to the received message authentication code MAC, or in the step 812, the message authentication code XRES is not equal to the message authentication code RES, the authentication result is failed, and the network application function NAF and the user equipment UE have to repeat the aforementioned mutual authentication method from the step 801.

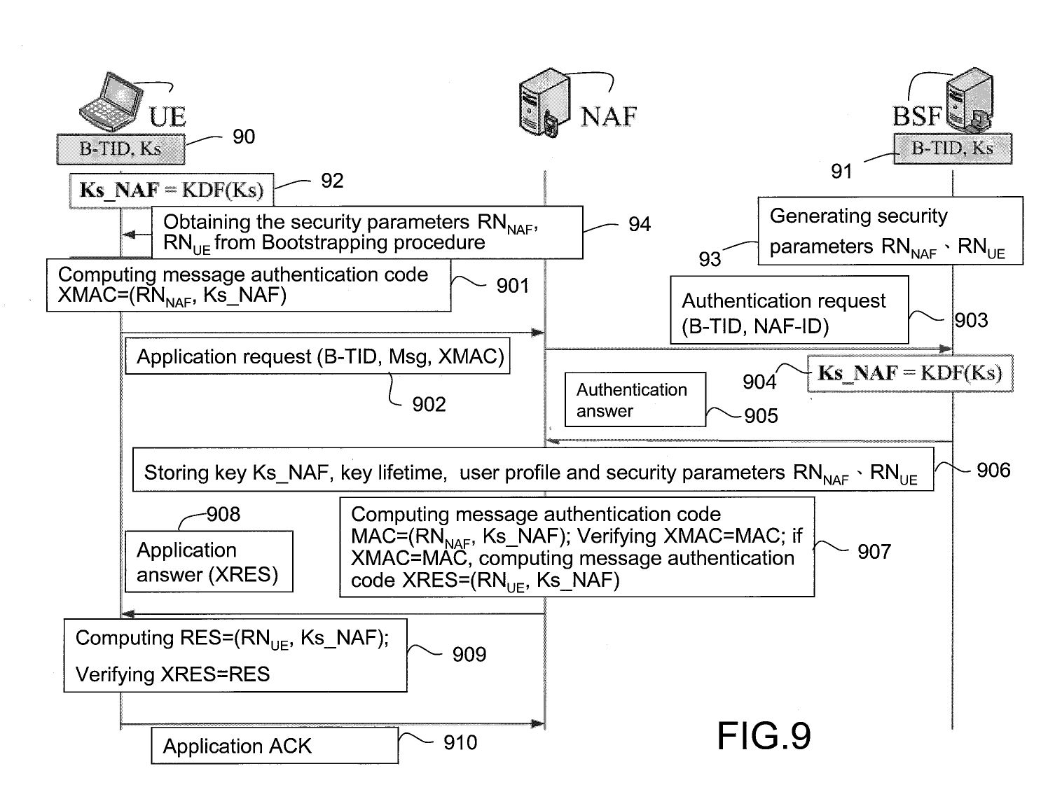

FIG. 9 is a schematic flowchart illustrating a mutual authentication method according to a sixth exemplary embodiment of the disclosure. The device authentication method of FIG. 9 implements the device authentication based on a shared key and pre-information between the user equipment UE and the network application function NAF. Moreover, the mutual authentication method of the present exemplary embodiment is different from the mutual authentication method of FIG. 8, since neither of the user equipment UE and the network application function NAF is required to generate a security parameter, and the security parameters RN_{NAF} and RN_{UE} required during the authentication process can be generated by the bootstrapping server function BSF before the authentication is performed between the user equipment UE and the network application function NAF, which is a step 93, and the obtained security parameters RN_{NAF} and RN_{UE} are the pre-information. Moreover, the security parameters RN_{NAF} and RN_{UE} can be provided to the user equipment UE and the network application function NAF by the bootstrapping server function BSF, or provided to the user equipment UE and the network application function NAF by the HSS.

The mutual authentication method is described below in accordance with FIG. 9. Steps 90 and 91 are respectively similar to the steps 80 and 81, and the user equipment UE and the bootstrapping server function BSF respectively obtain the key Ks and the bootstrapping transaction ID B-TID. In step 92, the user equipment UE generates the network application function key Ks NAF according to the key Ks, for example, Ks_NAF=KDF (Ks), where KDF is a key generation function. In step 94, the user equipment UE obtains the security parameters RN_{NAF} and RN_{UE} through the bootstrapping procedure of the GBA.

Actually, the mutual authentication method initiates from a step 901. In the step 901, the user equipment UE calculates a message authentication code XMAC=(RN_{NAF}, Ks_NAF) according to a calculation method of the message authentication code XMAC agreed previously through protocol between the network application function NAF and the user equipment UE by using the received security parameter RN_{NAF} and the network application function key Ks_NAF.

In step 902, the user equipment UE sends an application request to the network application function NAF, where the application request includes the bootstrapping transaction ID B-TID, the related message(s) Msg and the message authentication code XMAC. In step 903, the network application function NAF sends an authentication request to the bootstrapping server function BSF, where the authentication request includes the bootstrapping transaction ID B-TID and a network application function transaction ID NAF-TID.

In step S904, the bootstrapping server function BSF generates the network application function key Ks NAF according to the key Ks, for example, Ks_NAF=KDF (Ks).

In step S905, the bootstrapping server function BSF replies an authentication answer to the network application function NAF, where the authentication answer includes the network application function key Ks_NAF, a key lifetime of the network application function key Ks_NAF, a corresponding user profile and the security parameters RN_{NAF} and RN_{UE}. Here, the user profile can be a user security setting. In step 906, the network application function NAF stores the received network application function key Ks_NAF, the key lifetime, the corresponding user profile and the security parameters RN_{NAF} and RN_{UE}.

In step 907, the network application function NAF computes or calculates a message authentication code MAC=(RN_{NAF}, Ks_NAF) according to a calculation method of the message authentication code MAC agreed previously through protocol between the network application function NAF and the user equipment UE by using the obtained security parameter RN_{NAF} and the network application function key Ks_NAF.

The network application function NAF further determines whether the message authentication codes MAC=XMAC, and if the message authentication codes XMAC=MAC, the network application function NAF calculates another message authentication code XRES=(RN_{UE}, Ks_NAF) according to a calculation method of the message authentication code XRES agreed previously through protocol between the network application function NAF and the user equipment UE by using the message security parameter RN_{UE}.

In step 908, the network application function NAF replies an application answer to the user equipment UE, where the application answer includes the message authentication code XRES. In step 909, the user equipment UE calculates a message authentication code RES=(RN_{UE}, Ks_NAF) according to a calculation method of the message authentication code RES agreed previously through protocol between the network application function NAF and the user equipment UE by using the obtained security parameter RN_{UE} and the network application function key Ks_NAF. The user equipment UE further determines whether the message authentication codes RES=XRES, and if the message authentication codes RES=XRES, the mutual authentication between the user equipment UE and the network application function NAF is completed. Therefore, in step 910, the user equipment UE replies an application ACK to the network application function NAF to notify the network application function NAF that the mutual authentication is successful.

In the above step 907, if the message authentication code)(MAC is not equal to the received message authentication code MAC, or in the step 909, the message authentication code XRES is not equal to the received message authentication code RES, the authentication result is failed, and the network application function NAF and the user equipment UE have to repeat the aforementioned mutual authentication method from the step 901.

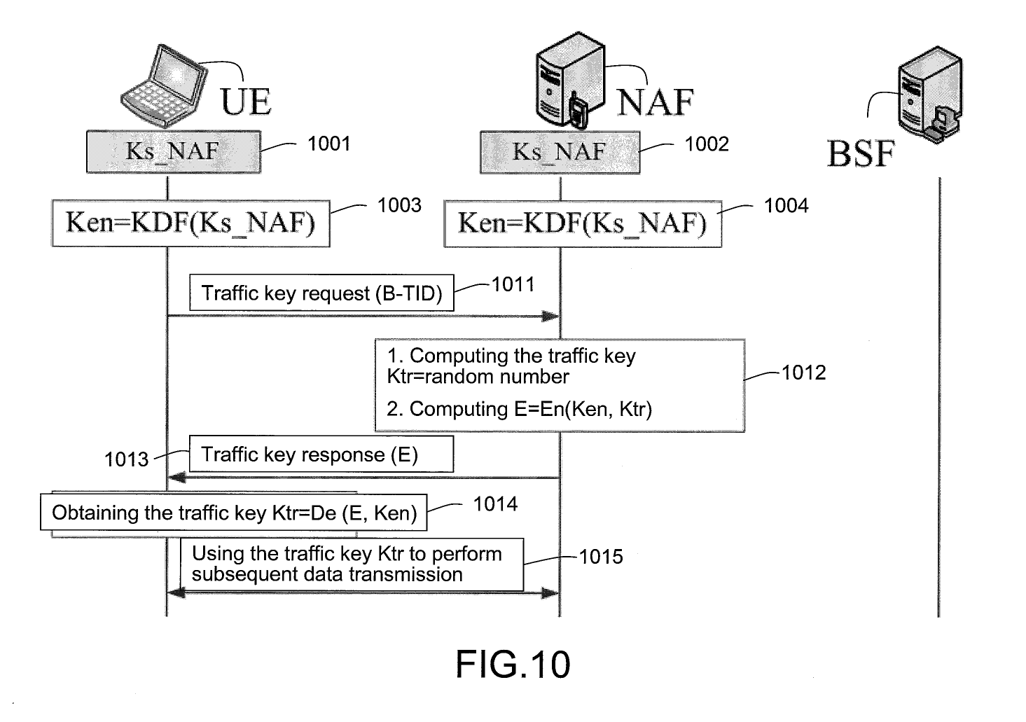

FIG. 10 is a schematic flowchart illustrating a key distribution method according to a seventh exemplary embodiment of the disclosure. Basically, the key distribution method of FIG. 10 is independent to the device authentication methods or the mutual authentication methods shown in FIG. 4 to FIG. 9, and after the authentication flow of any authentication method of FIG. 4 to FIG. 9 is completed, in a step 1001 and a step 1002, the user equipment UE and the network application function NAF respectively obtain the network application function key Ks_NAF, and in collaboration with the obtained network application function key Ks_NAF, the subsequent flow of the key distribution method is described below.

Referring to FIG. 10, the key distribution method of FIG. 10 is actually initiated from a step 1003. In the step 1003, the user equipment UE generates a key encryption key Ken=KDF (Ks_NAF) according to a key generation function KDF by using the obtained network application function key Ks NAF. In step 1004, similarly, the network application function NAF generates the key encryption key Ken=KDF (Ks_NAF) according to the key generation function KDF by using the obtained network application function key Ks_NAF. For example, in the key generation function KDF of the key encryption key Ken, the network application function key Ks_NAF is taken as a first input value, and a current number of times for generating the key encryption key Ken is taken as an index, and the key encryption key Ken is dynamically generated according to the first input value (the network application function key Ks_NAF) and the index.

In step 1011, the user equipment UE sends a traffic key request to the network application function NAF, where the traffic key request includes the bootstrapping transaction ID B-TID. Utilization of a traffic key (or a traffic encryption key) Ktr can reduce a utilization frequency of the network application function key Ks_NAF, such that new traffic keys Ktr can be frequently generated to improve security of data transmission between the user equipment UE and the network application function NAF.

Therefore, in step 1012, the network application function NAF generates a random number to serve as the traffic key Ktr. However, the present disclosure is not limited thereto, and the random instance described in the step 507 of FIG. 5 can be used to generate the traffic key Ktr. The random instance can be, for example, a geographic position parameter (for example, a longitude and a latitude) of the user equipment UE, any name configured by the user of the user equipment UE, a user name of the user of the user equipment UE, an medium access control (MAC) address ID of the user equipment UE, or the above parameters plus an index, etc. Moreover, the network application function NAF uses the key encryption key Ken to cipher the traffic key Ktr to generate another security parameter E=En (Ken, Ktr).

In step 1013, the network application function NAF replies a traffic key answer to the user equipment UE, and the traffic key answer includes the security parameter E. In step S1014, the user equipment UE deciphers the security parameter E by using the key encryption key Ken obtained in the step 1003 to obtain the traffic key Ktr=De (E, Ken). Then, in step 1015, the network application function NAF and the user equipment UE can use the traffic key Ktr to perform subsequent data transmission or other security flows.

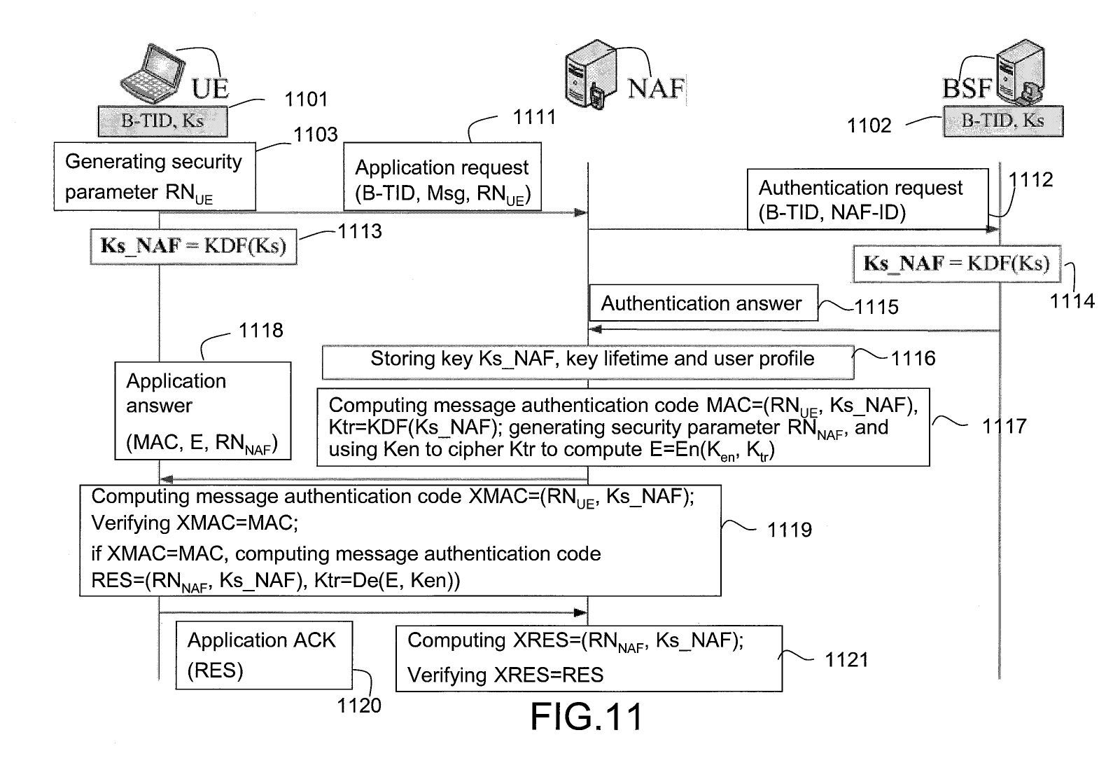

FIG. 11 is a schematic flowchart illustrating an authentication and key distribution method according to an eighth exemplary embodiment of the disclosure. The authentication and key distribution method of FIG. 11 basically combines the mutual authentication method of FIG. 8 and the key distribution method of FIG. 10. Technical details of the authentication and key distribution method are described below in accordance with FIG. 11.

Referring to FIG. 11, steps 1101 and 1102 are respectively similar to the steps 80 and 81, by which the user equipment UE and the bootstrapping server function BSF respectively obtain the key Ks and the bootstrapping transaction ID B-TID. In step 1103, the user equipment UE generates the security parameter RN_{UE}. In step 1111, the user equipment UE sends an application request to the network application function NAF, where the application request includes the bootstrapping transaction ID B-TID, the related message(s) Msg and the security parameter RN_{UE}.

In step 1112, the network application function NAF sends an authentication request to the bootstrapping server function BSF, where the authentication request includes the bootstrapping transaction ID B-TID and a network application function transaction ID NAF-TID. In step 1113, the user equipment UE generates a network application function key Ks_NAF according to the key Ks, for example, Ks_NAF=KDF (Ks), where KDF is a key generation function. In step 1114, the bootstrapping server function BSF generates the network application function key Ks_NAF according to the key Ks, for example, Ks_NAF=KDF (Ks). It should be noted that the step 1113 can be executed while the steps 1111 and 1112 are executed.

In step 1115, the bootstrapping server function BSF replies an authentication answer to the network application function NAF, where the authentication answer includes the network application function key Ks_NAF, a key lifetime of the network application function key Ks_NAF and a corresponding user profile. Here, the user profile can be a user security setting. In step 1116, the network application function NAF stores the received network application function key Ks_NAF, the key lifetime and the corresponding user profile.

In step 1117, the network application function NAF computes or calculates a message authentication code MAC=(RN_{UE}, Ks_NAF) according to a calculation method of the message authentication code MAC agreed previously through protocol between the network application function NAF and the user equipment UE by using the obtained security parameter RN_{UE} and the network application function key Ks_NAF; computes or calculates a traffic key Ktr=KDF (Ks_NAF) according to another key generation function by using the network application function key Ks_NAF; generates a security parameter RN_{NAF}, and uses a key encryption key Ken to cipher the traffic key Ktr to generate another security parameter E=En (Ken, Ktr). It is assumed that after the network application function NAF and the user equipment UE generate the network application function key Ks NAF in the steps 1113 and 1114, the network application function NAF and the user equipment UE calculate the key encryption key Ken=KDF (Ks_NAF) according to another key generation function KDF by using the generated network application function key Ks_NAF.

In step 1118, the network application function NAF replies an application answer to the user equipment UE, where the application answer includes the message authentication code MAC, the security parameter RN_{NAF} and the security parameter E.

In step 1119, the user equipment UE calculates a message authentication code XMAC=(RN_{UE}, Ks_NAF) according to a calculation method of the message authentication code XMAC agreed previously through protocol between the network application function NAF and the user equipment UE by using the security parameter RN_{UE} and the network application function key Ks_NAF. Since the message authentication code XMAC and the message authentication code MAC are security symmetric, the user equipment UE further determines whether the generated message authentication code XMAC is equal to the message authentication code MAC received in the step 1118. This is to determine whether XMAC=MAC, and if XMAC=MAC, the user equipment UE authenticates the network application function NAF. Therefore, the user equipment UE calculates another message authentication code RES=(RN_{NAF}, Ks_NAF) according to a calculation method of the message authentication code RES agreed previously through protocol between the network application function NAF and the user equipment UE by using the message security parameter RN_{NAF} and the network application function key Ks_NAF.

In step 1120, the user equipment UE replies an application ACK to the network application function NAF, where the application ACK includes the message authentication code RES.

In step 1121, the network application function NAF calculates a message authentication code XRES=(RN_{NAF}, Ks_NAF) according to a calculation method of the message authentication code XRES agreed previously through protocol between the network application function NAF and the user equipment UE by using the message security parameter RN_{NAF} and the network application function key Ks_NAF. Since the message authentication code XRES and the message authentication code RES are security symmetric, the network application function NAF further determines whether the generated message authentication code XRES is equal to the message authentication code RES received in the step 1120. This is to determine whether XRES=RES, and if XRES=RES, the mutual authentication between the user equipment UE and the network application function NAF is completed.

In the step 1119, if the message authentication code XMAC is not equal to the received message authentication code MAC, or in the step 1121, the message authentication code XRES is not equal to the message authentication code RES, the authentication result is failed, and the network application function NAF and the user equipment UE have to repeat the aforementioned device authentication method from the step 1111.

The aforementioned parameters such as the network application function key Ks_NAF, the key Ks, the security parameter RN_{NAF}, the security parameter RN_{UE}, the random instance, the message authentication code MAC, the message authentication code XMAC, the message authentication code RES, the message authentication code XRES, the X.509 certificate, the network application function transaction ID NAF-TID, the bootstrapping transaction ID B-TID, and the security parameter E, etc. are widely regarded as security materials in the present disclosure.

In summary, the exemplary embodiments of the disclosure provide an authentication method, a key distribution method and an authentication and key distribution method adapted for machine type communication (MTC). The methods are adapted to a wireless communication system including a home subscriber server, a bootstrapping server function, a network application function and a user equipment. By generating the security parameters corresponding to the network application function or/and the user equipment, and generating the network application function key according to the key obtained through the bootstrapping procedure of the generic bootstrapping architecture, and generating the message authentication codes according to the security parameters and the network application function key, the device authentication or the mutual authentication can be achieved. Moreover, the network application function key can also be transmitted according to the certificate of the public key infrastructure, or the traffic key is generated according to the network application function key, such that the traffic key is frequently updated for improving security of the MTC. In this way, the device authentication or the mutual authentication between the network application function and the user equipment is implemented to achieve a secure key distribution, so as to satisfy the requirement of efficient security mechanism of the MTC.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An authentication method, adapted for a wireless communication system comprising a home subscriber server, a bootstrapping server function, a network application function and at least a user equipment, the authentication method comprising:
the at least a user equipment transmitting an application request comprising at least a first security material to the network application function, wherein the at least a first security material is not a first key directly obtained through a bootstrapping procedure of a generic bootstrapping architecture;
the network application function generating a second security material according to the at least a first security material, wherein the second security material is not the first key directly obtained through the bootstrapping procedure of the generic bootstrapping architecture;
the network application function replying an application answer comprising at least the second security material to the at least a user equipment; and
the network application function authenticating the at least a user equipment according to the second security material, or the at least a user equipment authenticating the network application function according to the second security material.

2. The authentication method as claimed in claim 1, wherein the at least a first security material is a certificate of a public key infrastructure (PKI), the second security material is a ciphered security parameter, and the authentication method further comprises:
the network application function extracting a public key from the certificate;
the network application function generating a second key according to the first key obtained through the bootstrapping procedure of the generic bootstrapping architecture;
the network application function using the public key to cipher the second key to generate the ciphered security parameter; and
the at least a user equipment using a private key corresponding to the public key to decipher the ciphered security parameter to obtain the second key.

3. The authentication method as claimed in claim 1, further comprising:
after the at least a user equipment transmits the application request comprising the at least a first security material to the network application function, the network application function transmitting an authentication request to the bootstrapping server function, wherein the authentication request comprises at least a transaction identification code.

4. The authentication method as claimed in claim 3, further comprising:
the bootstrapping server function replying an authentication answer comprising at least a third security material to the network application function, wherein the at least a third security material comprises a second key generated according to the first key obtained through the bootstrapping procedure of the generic bootstrapping architecture, a key lifetime of the first key, and a user profile of the first key.

5. The authentication method as claimed in claim 4, wherein the at least a third security material further comprises a first security parameter, and the authentication method further comprises:
the network application function using the first security parameter and the second key to generate a message authentication code to serve as the second security material.

6. The authentication method as claimed in claim 4, wherein the at least a third security material further comprises a first security parameter and a second security parameter, and the authentication method further comprises:
the network application function using the second security parameter and the second key to generate a message authentication code to serve as the second security material.

7. The authentication method as claimed in claim 4, wherein the second security material comprises a security parameter generated by the network application function.

8. The authentication method as claimed in claim 4, wherein the second security material comprises a message authentication code generated by the network application function.

9. The authentication method as claimed in claim 4, wherein the second security material comprises a message authentication code and a security parameter generated by the network application function.

10. The authentication method as claimed in claim 4, wherein after the network application function replies the application answer comprising the second security material to the at least a user equipment, the authentication method further comprises:
the at least a user equipment replying an application acknowledgement comprising a message authentication code to the network application function.

11. A key distribution method, adapted for a wireless communication system comprising a home subscriber server, a bootstrapping server function, a network application function and at least a user equipment, the key distribution method comprising:
the at least a user equipment transmitting a traffic key request to the network application function, wherein the traffic key request comprises an identification code;
the network application function generating a traffic key and using a key encryption key to cipher the traffic key to generate a security parameter; and
the network application function replying a traffic key acknowledgement comprising the security parameter to the at least a user equipment.

12. The key distribution method as claimed in claim 11, further comprising:
using a network application function key to generate the key encryption key according to a key generation function.

13. The key distribution method as claimed in claim 12, wherein the step that the network application function generating the traffic key comprises:
generating a random instance to serve as the traffic key.

14. The key distribution method as claimed in claim 12, wherein before the at least a user equipment transmits the traffic key request to the network application function, the key distribution method further comprises:
the at least a user equipment and the network application function respectively obtaining the network application function key from the home subscriber server or the bootstrapping server function; and
the at least a user equipment and the network application function respectively generating the key encryption key according to the key generation function by using the network application function key.

15. The key distribution method as claimed in claim 14, wherein after the at least a user equipment receives the traffic key acknowledgement comprising the security parameter, the key distribution method further comprises:
the at least a user equipment using the key encryption key to decipher the security parameter to obtain the traffic key.

16. An authentication and key distribution method, adapted for a wireless communication system comprising a home subscriber server, a bootstrapping server function, a network application function and at least a user equipment, the authentication and key distribution method comprising:
the at least a user equipment transmitting an application request comprising a first identification code, a first security parameter and a message to the network application function;
the network application function transmitting an authentication request comprising the first identification code and a second identification code to the bootstrapping server function after receiving the application request;
the bootstrapping server function replying an authentication answer comprising a network application function key, a key lifetime of the network application function key, and a user profile to the network application function;
the network application function replying an application answer comprising at least a first message authentication code, a second security parameter and a third security parameter to the at least a user equipment; and
the at least a user equipment transmitting an application acknowledgement comprising a second message authentication code to the network application function.

17. The authentication and key distribution method as claimed in claim 16, wherein before the at least a user equipment transmits the application request to the network application function, the authentication and key distribution method further comprises:
the at least a user equipment generating the first security parameter, wherein the first identification code is a bootstrapping transaction identification code.

18. The authentication and key distribution method as claimed in claim 17, wherein the second identification code is a network application function identification code.

19. The authentication and key distribution method as claimed in claim 18, wherein before the network application function replies the application answer to the at least a user equipment, the authentication and key distribution method further comprises:
the network application function using the network application function key and the first security parameter to generate the first message authentication code;
the network application function using the network application function key to generate a traffic key;
the network application function generating the third security parameter; and
the network application function using a key encryption key to cipher the traffic key to generate the second security parameter.

20. The authentication and key distribution method as claimed in claim 19, wherein before the at least a user equipment transmits the application acknowledgement to the network application function, the authentication and key distribution method further comprises:
the at least a user equipment using the first security parameter and the network application function key to generate a third message authentication code; and
the at least a user equipment authenticating the network application function by verifying whether the third message authentication code is equal to the first message authentication code.

21. The authentication and key distribution method as claimed in claim 20, wherein after the at least a user equipment verifies that the third message authentication code is equal to the first message authentication code, the authentication and key distribution method further comprises:
the at least a user equipment generating the second message authentication code by using the third security parameter and the network application function key;
the network application function using the third security parameter and the network application function key to generate a fourth message authentication code after receiving the application acknowledgement; and
the network application function authenticating the at least a user equipment by verifying whether the fourth message authentication code is equal to the second message authentication code.
